(19) United States
(12) Patent Application Publication
(10) Pub. No.: US 2026/0287354 A1
(43) Pub. Date: Sep. 24, 2026

(54) Rotating Laser

(71) Applicant: Robert Bosch GmbH, Stuttgart (DE)

(72) Inventor: Tobias Roehm, Wildberg-Sulz (DE)

(21) Appl. No.: 19/569,639

(22) Filed: Mar. 17, 2026

(30) Foreign Application Priority Data
Mar. 20, 2025 (DE) 10 2025 110 739.4

(51) Int. Cl. G01C 15/00

(52) U.S. Cl. CPC G01C 15/004

(57) ABSTRACT

A rotating laser includes a housing in which a drive unit for rotatably driving a spindle is arranged for rotation of a laser beam. A beam deflector for deflecting the laser beam is arranged on the spindle. The spindle includes a holder that has at least two receiving elements which form a receptacle in which the beam deflector is receivable. The at least two receiving elements are configured to mechanically fix the beam deflector in the receptacle.

This application claims priority under 35 U.S.C. § 119 to patent application no. DE 10 2025 110 739.4, filed on Mar. 20, 2025 in Germany, the disclosure of which is incorporated herein by reference in its entirety.

### BACKGROUND

The present disclosure relates to a rotating laser having a housing, in which a drive unit for rotatably driving a spindle is arranged for rotation of a laser beam, wherein a beam deflector for deflecting the laser beam is arranged on the spindle.

A rotating laser having such a drive unit for rotating a laser beam is known from the prior art. The drive unit is arranged in a housing of the rotating laser. Here, a spindle for rotatably driving is arranged on the drive unit, wherein a beam deflector for deflecting the laser beam is arranged on the spindle.

### SUMMARY

The disclosure relates to a rotating laser having a housing, in which a drive unit for rotatably driving a spindle is arranged for rotation of a laser beam, wherein a beam deflector for deflecting the laser beam is arranged on the spindle. The spindle comprises a holder that comprises at least two receiving elements which form a receptacle in which the beam deflector is receivable, wherein the at least two receiving elements are configured to mechanically fix the beam deflector in the receptacle.

The disclosure thus enables the provision of a rotating laser in which a secure and reliable arrangement of the beam deflector may be achieved by the at least two receiving elements.

Preferably, the receptacle comprises two positioning surfaces for positioning the beam deflector.

Thus, an exact and precise arrangement of the beam deflector in the receptacle may be achieved.

Preferably, the beam deflector is fixed in the receptacle by way of at least one adhesive bond.

Thus, a secure and reliable fixation of the beam deflector in the receptacle may be achieved.

Preferably, along a transverse direction of the two positioning surfaces, an adhesive receptacle for receiving a first adhesive is arranged between the two positioning surfaces, wherein the first adhesive forms a planar adhesive bond.

Thus, the planar adhesive bond may be formed in a simple manner.

Preferably, in two recesses which are arranged transversely to the two positioning surfaces and between a first receiving element and a second receiving element, a second adhesive is arranged for forming a second adhesive bond.

Thus, a further adhesive bond for secure arrangement of the beam deflector may be provided simply and straightforwardly.

According to one embodiment, the second adhesive bond is a fillet adhesive bond.

Thus, a suitable adhesive bond may be provided in a simple manner.

Preferably, a stop is formed on at least one end face of the two positioning surfaces.

Thus, a secure and reliable arrangement of the beam deflector in the receptacle of the holder may be achieved.

The holder preferably comprises a fastening section for arrangement on a free end of the spindle.

Thus, an arrangement of the beam deflector on the spindle by way of the holder may be achieved in a simple manner.

Preferably, the fastening section comprises an inner receptacle having a flat portion, wherein the spindle has, at its free end, a corresponding receptacle having a flat portion.

Thus, a defined alignment of the beam deflector on the spindle may be achieved.

Preferably, a cap having an inner receptacle for receiving the holder is assigned to the holder.

Thus, a secure and reliable arrangement of the cap on the holder may be achieved.

Preferably, the cap comprises a receptacle for receiving a wedge prism.

Thus, an arrangement of the wedge prism on the beam deflector may be achieved in a simple manner.

Preferably, a cage is assigned to the holder.

Thus, a cover for the holder may be provided simply and straightforwardly.

Preferably, a distance between an inner surface of the cage and a surface of the beam deflector is smaller than a depth of the inner receptacle.

Alternatively, a distance between an interior surface of the cage and a surface of a cap assigned to the holder is smaller than a depth of the inner receptacle.

Thus, a secure and reliable arrangement of the beam deflector may be achieved.

### BRIEF DESCRIPTION OF THE DRAWINGS

The disclosure is explained in greater detail in the following description on the basis of exemplary embodiments illustrated in the drawings. It shows:

FIG. 1 a perspective view of a rotating laser according to the disclosure having a drive unit,

FIG. 2 a perspective exploded view of a spindle assigned to the drive unit of FIG. 1 and of a bearing arrangement assigned to the spindle,

FIG. 3 a longitudinal section through the bearing arrangement of the spindle of FIG. 2 in the assembled state,

FIG. 4 a schematic view of the bearing arrangement of FIG. 2 and FIG. 3 as seen from a free end of the spindle,

FIG. 5 a perspective view of the drive unit of FIG. 1 having a determination unit and a beam deflector,

FIG. 6 a longitudinal section through the drive unit of FIG. 5,

FIG. 7 a perspective view of the spindle of FIG. 2 to FIG. 6 having the determination unit of FIG. 5 and FIG. 6,

FIG. 8 a top view of a printed circuit board assigned to the drive unit of FIG. 1 to FIG. 7,

FIG. 9 a perspective view of the spindle of FIG. 2 to FIG. 8 having a toothed disk and the beam deflector of FIG. 1, FIG. 5, and FIG. 6,

FIG. 10 a longitudinal section through the bearing arrangement of the spindle and of the toothed disk of FIG. 9,

FIG. 11 a longitudinal section through the drive unit of FIG. 1 to FIG. 10 having an alternative fixation of the bearing arrangement,

FIG. 12 a perspective view of the spindle having the determination unit of FIG. 1, FIG. 5 to FIG. 7, and FIG. 9 to FIG. 11,

FIG. 13 a top view of the printed circuit board of FIG. 8 having an absolute encoder,

FIG. 14a-c a top view of the spindle of FIG. 1 to FIG. 7 and FIG. 9 to FIG. 12 having the printed circuit board of FIG. 8 and the beam deflector of FIG. 1, FIG. 5, FIG. 6, and FIG. 9 in the course of a calibration process,

FIG. 15a-d a top view of the spindle having the printed circuit board and the beam deflector of FIG. 14a to FIG. 14c in the course of an absolute positioning at a start of the rotating laser of FIG. 1,

FIG. 16 a partial longitudinal section through the rotating laser of FIG. 1,

FIG. 17 an exploded view of the beam deflector of FIG. 1, FIG. 5, FIG. 6, FIG. 9, FIG. 14a to FIG. 16 having a cap,

FIG. 18 a sectional view of the beam deflector of FIG. 17 at a maximum deflection,

FIG. 19 a perspective view of the beam deflector of FIG. 1, FIG. 5, FIG. 6, FIG. 9, FIG. 14a to FIG. 18, and

FIG. 20 a sectional view of the beam deflector of FIG. 18 without a cap, at a maximum deflection.

### DETAILED DESCRIPTION

In the figures, elements having the same or comparable function are provided with identical reference signs and are described in greater detail only once.

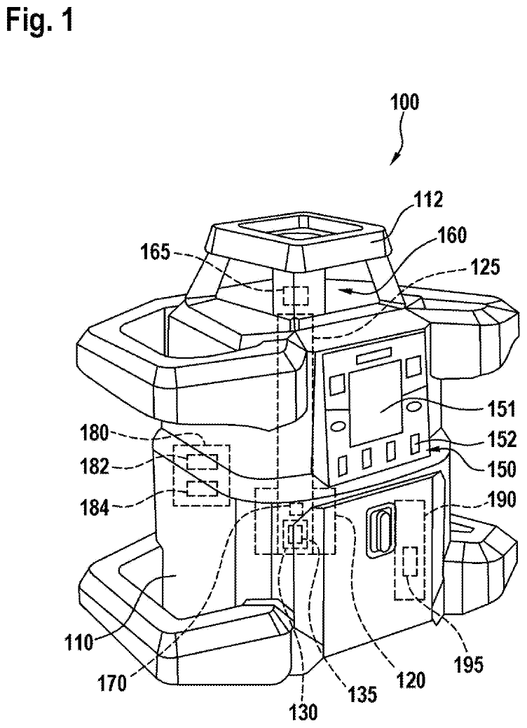

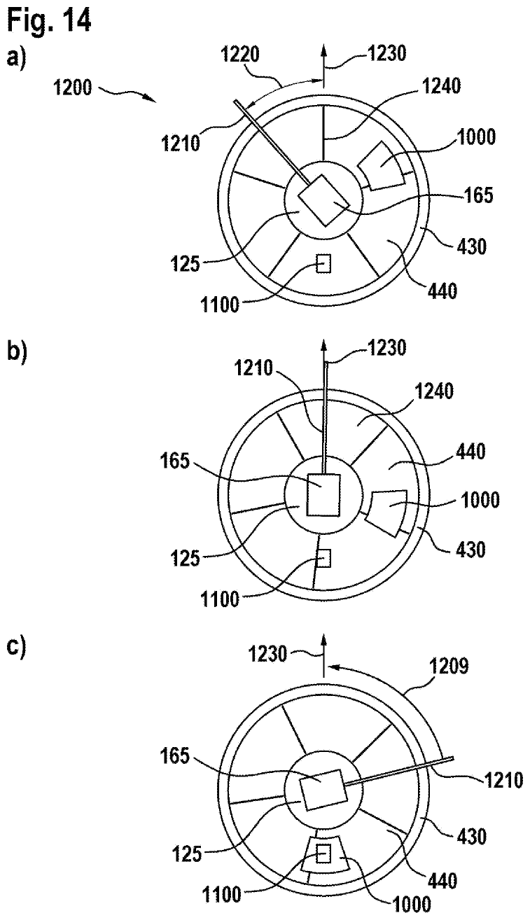

FIG. 1 shows an exemplary rotating laser 100 having a housing 110 in which a laser unit 130 having a laser diode 135 for generating a laser beam (1210 in FIG. 14) is arranged. In the context of the present disclosure, a “rotating laser” may also be understood as meaning a construction laser or a leveling laser. Furthermore, a drive unit 120 for rotatably driving a spindle 125 is, by way of example, arranged in the housing 110. Preferably, the drive unit 120 is configured as an electric motor.

The laser unit 130 is arranged on the spindle 125 such that, by rotation of the spindle 125, the laser beam (1210 in FIG. 14) generated by the laser unit 130 rotates in an assigned plane. For this purpose, a rotating head 160 having a beam deflector 165 is preferably assigned to the spindle 125. The beam deflector 165 is preferably configured to deflect the laser beam, whereby the laser beam (1210 in FIG. 14) projects the assigned plane. Depending on the configuration of the rotary laser 100, the projected plane may extend horizontally, vertically, or, for example, with a defined inclination angle relative to the ground surface. Furthermore, the beam deflector 165 may be formed as a beam splitter, whereby the laser beam is projected both into the plane and emitted along a direction perpendicular to the plane.

Furthermore, an electronics unit 190 having a control and monitoring device 195 is preferably arranged in the housing 110. The control and monitoring device 195 is preferably configured to control a laser power of the laser unit 130 as a function of a respective operating mode. Here, a rotational speed of the spindle 125 of the drive unit 120 is controlled or regulated. Preferably, a determination unit 170 is assigned to the spindle 125 for this purpose.

By way of example, a cage 112 assigned to the rotation head 160 is assigned to the housing 110 for protection against striking of the rotating head 160.

The electronics unit 190 is assigned to an operating unit 150 having a display 151 and an input unit 152. The operating unit 150 is preferably connected to the electronics unit 190, in particular, to the control and monitoring device 195, in terms of control or regulation. The input unit 152 preferably comprises at least one keypad. Alternatively, the input unit 152 may comprise a rotating control, a touchscreen, a slider, a remote control, or the like. Via the input unit 152, a user may input, for example, a rotational speed for the spindle 125. Alternatively, the rotational speed of the laser unit 130 may be automatically controllable in at least one operating mode.

Preferably, the rotating laser 100 comprises a leveling unit 180. The leveling unit 180 preferably comprises at least one inclination sensor 184, which is configured to ascertain an inclination of the rotating head 160, in particular, of the beam deflector 165, and/or of the laser unit 130 relative to a predefined direction, preferably a horizontal direction, or relative to the vertical. Furthermore, the leveling unit 180 preferably comprises at least one inclination adjustment motor 182, which is configured to align the rotating head 160, in particular, the beam deflector 165, and/or the laser unit 130 relative to the vertical as a function of a position determined by way of the at least one inclination sensor 184, preferably an inclination of the laser unit 130 and/or of the rotating head 160.

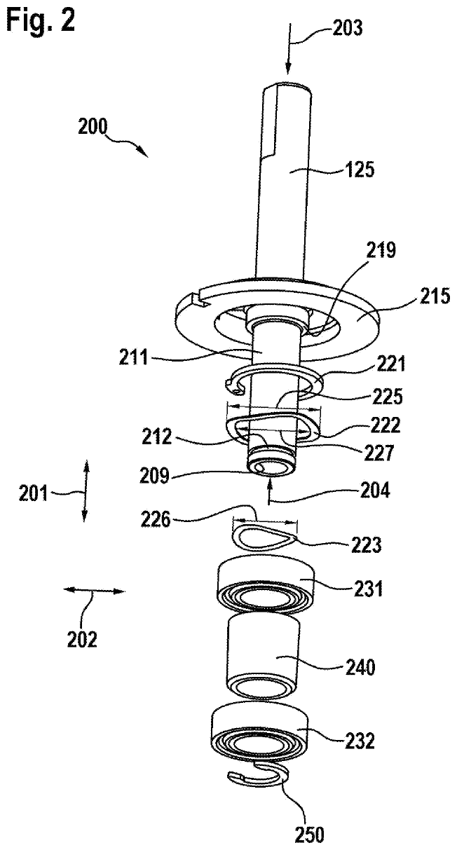

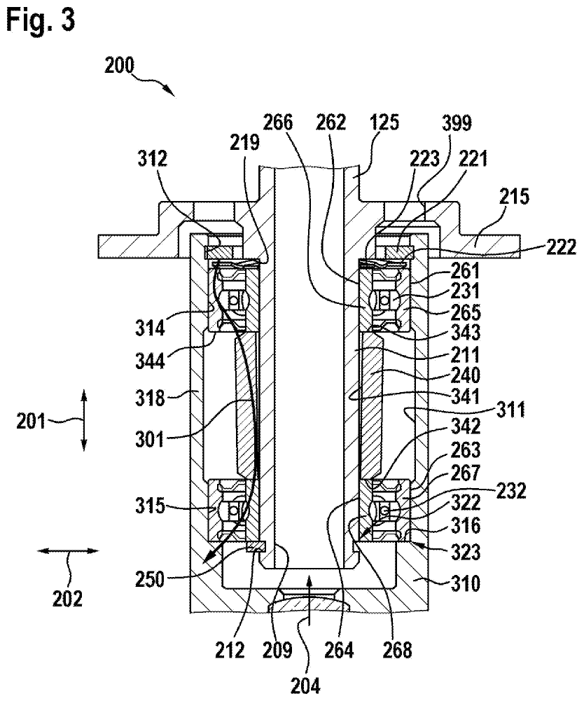

FIG. 2 shows the spindle 125 of the drive unit 120 of the rotating laser 100 of FIG. 1. The spindle 125 comprises a first, upper end 203 and a second, lower end 204. Preferably, the beam deflector 165 of FIG. 1 is arranged at the first end 203. At the second end 204, the spindle 125 is supported in a stator (310 in FIG. 3) via a bearing arrangement 200.

Preferably, the bearing arrangement 200 comprises two bearing elements 231, 232, via which the spindle 125 is supported in the stator (310 in FIG. 3). Preferably, a spacer element 240 is provided, which spaces the two bearing elements 231, 232 apart from one another along a longitudinal extent 201 of the spindle 125.

Preferably, a fixing element 221 for fixing the spindle 125 in the direction of its longitudinal extent 201 on the stator (310 in FIG. 3) is assigned to the spindle 125. At the second end 204 of the spindle 125, an assigned bearing element 232 of the two bearing elements 231, 232 is preferably secured on the spindle 125 by way of an additional fixing element 250 along the longitudinal extent 201 of the spindle 125. Preferably, the spindle 125 comprises, at its second end 204, a receptacle 212 for receiving the additional fixing element 250.

Preferably, the spindle 125 comprises a magnet carrier 215. Preferably, the spindle 125 is connected to the magnet carrier 215. Here, the magnet carrier 215 is arranged on an outer circumference 211 of the spindle 125 and extends the spindle 125 in a radial direction 202 of the spindle 125. Preferably, the magnet carrier 215 is formed in a disk shape. According to FIG. 2, the magnet carrier 215 is formed in one piece with the spindle 125. On a side of the magnet carrier 215 facing the second end 204 of the spindle 125, a retaining edge 219 is formed.

Preferably, along the longitudinal extent 201 of the spindle 125, at least one spring element 222, 223 is arranged between the fixing element 221 and/or the additional fixing element 250 and a respectively assigned bearing element 231, 232 of the two bearing elements 231, 232. Two spring elements 222, 223 are arranged between the fixing element 221 and the bearing element 231. The spring element 222 comprises an outer diameter 225 and an inner diameter 227. The spring element 223 comprises an outer diameter 226. An inner diameter of the spring element 223 is preferably adapted to a diameter of the spindle 125. Preferably, the inner diameter 227 of the spring element 222 is greater than the outer diameter 226 of the spring element 223. The fixing element 221 and/or the additional fixing element 250 may, for example, be formed as a snap ring.

FIG. 3 shows the spindle 125 of FIG. 1 and FIG. 2, which is supported by way of the bearing arrangement 200 of FIG. 2 in a stator 310 assigned to the drive unit 120 of FIG. 1. The stator 310 comprises, by way of example, a cylindrical base body 318 having an inner receptacle 311. The bearing arrangement 200 for supporting the spindle 125 is arranged in the inner receptacle 311.

Preferably, at least one of the two bearing elements 231, 232 is press-fitted onto the outer circumference 211 of the spindle 125 and/or at least one of the two bearing elements 231, 232 is press-fitted into a bearing seat 314, 315 assigned to the inner receptacle 311. As a result, play between the spindle 125 and the assigned bearing element 231, 232 may be eliminated at least substantially, that is to say within customary manufacturing tolerances.

An upper bearing seat 314 is assigned to the bearing element 231 and a lower bearing seat 315 is assigned to the bearing element 232. Preferably, a bearing seat 315 assigned to the second, or free, end 204 of the spindle 125 in the inner receptacle 311 comprises a bearing surface 316 for abutment of the bearing element 232 assigned to the bearing seat 315 along the longitudinal extent 201 of the spindle 125.

The bearing elements 231, 232 are preferably formed as ball bearings. Here, the bearing element 231 preferably comprises an inner ring 266 and an outer ring 265. The outer ring 265 forms an outer circumference 261 of the bearing element 231 and the inner ring 266 forms an inner circumference 262 of the bearing element 231. Analogously thereto, the bearing element 232 preferably has an inner ring 268 and an outer ring 267. The outer ring 267 forms an outer circumference 263 of the bearing element 232 and the inner ring 268 forms an inner circumference 264 of the bearing element 232. The inner circumference 262 of the bearing element 231 and the inner circumference 264 of the bearing element 232 are arranged on the outer circumference 211 of the spindle 125. Furthermore, the outer circumference 261 of the bearing element 231 is arranged at the bearing seat 314 and the outer circumference 263 of the bearing element 232 is arranged at the bearing seat 315.

As described above, the spacer element 240 is arranged, by way of example, between the two bearing elements 231, 232. The spacer element 240 is preferably sleeve-shaped and comprises an inner receptacle 341. The inner receptacle 341 is arranged on the outer circumference 211 of the spindle 125. The outer ring 267 of the bearing element 232 abuts the bearing surface 316 of the inner receptacle 311 of the stator 310 along the longitudinal extent 201 of the spindle 125. Preferably, the inner ring 268 of the bearing element 232 rests, in sections in the circumferential direction, against the fixing element 250. Preferably, an end face 342 of the spacer element 240 facing the bearing element 232 rests against the bearing element 232. The end face 342 of the spacer element 240 rests against the inner ring 268 of the bearing element 232. Furthermore, an end face 344 of the bearing element 231 facing the spacer element 240 rests, by way of example, against an end face 343 facing the bearing element 231. The inner ring 266 of the bearing element 231 rests against the end face 343 of the spacer element 240.

Preferably, as described above, two spring elements 222, 223 are arranged between the fixing element 221 and the bearing element 231. Preferably, the spring elements 222, 223 are arranged coaxially with respect to one another. Alternatively or optionally, a spring element 222 is arrangeable between the lower bearing element 232 and the additional fixing element 250, or at a location 322, and/or a spring element 223 is arrangeable at a location 323. Preferably, at least one of the two spring elements 222, 223 is formed as a wave spring. Tolerance compensation along the longitudinal extent 201 of the spindle 125 is preferably achieved via the spring elements 222, 223.

At this point, it should be noted that the spring element 223, the spacer element 240, and the additional fixing element 250 may be dispensed with when both bearing elements 231, 232 are arranged on the spindle 125 by way of an interference fit between the inner circumference 262, 264 of the bearing elements 231, 232 and the outer circumference 211 of the spindle 125, since in this case the respective inner rings of the bearing elements 231, 232 are fixed relative to one another along the longitudinal extent 201 of the spindle 125 and the need for a corresponding tolerance compensation is eliminated.

Preferably, the inner receptacle 311 of the stator 310 comprises a fixing receptacle 312, which is configured to receive the fixing element 221. Preferably, the fixing element 221 is arranged in the fixing receptacle 312. As a result, the spindle 125 may be fixed by way of the fixing element 221 in the direction of its longitudinal extent 201, or in its axial direction, in the inner receptacle 311. The bearing element 231 preferably rests against the fixing element 221 and thus fixes the spindle 125 in the direction of its longitudinal extent 201, or in its axial direction, in the inner receptacle 311.

Furthermore, FIG. 3 illustrates the magnet carrier 215 of the spindle 125, which, along the radial direction 202 of the spindle 125, covers, by way of example, at least the inner receptacle 311. The magnet carrier 215 projects beyond the stator 310 in the radial direction 202 of the spindle 125. Preferably, the magnet carrier 215 comprises at least one recess 399 in order to enable access into the inner receptacle 311 of the stator 310. Preferably, the at least one recess 399 enables access to the fixing element 221 fixable in the fixing receptacle 312.

In the assembly of the spindle 125 in the stator 310, the fixing element 221 is preferably first arranged in a region of the spindle 125 facing the magnet carrier 215. Subsequently, the preferably two bearing elements 231, 232 and the spacer element 240 may be arranged on the outer circumference 211 of the spindle 125. Here, preferably at least one of the two bearing elements 231, 232 is press-fitted onto the outer circumference 211 of the spindle 125 and/or at least one of the two bearing elements 231, 232 is press-fitted into a bearing seat 314, 315 assigned to the inner receptacle 311. Thereafter, arranging the spindle 125 in the inner receptacle 311 of the stator 310 preferably takes place. Finally, the fixing element 221 may be arranged in the fixing receptacle 312 of the stator 310. Here, by way of a tool through the recess 399 of the magnet carrier 215, the fixing element 221 is preferably moved from the region of the spindle 125 facing the magnet carrier 215 into the fixing receptacle 312. Preferably, before arranging the bearing elements 231, 232 and the spacer element 240 on the spindle 125, the additional fixing element 250 is arranged or secured in the receptacle 212 at the end 204 of the spindle 125.

A force flow through the bearing elements 231, 232 is illustrated by way of an arrow 301. Preferably, the force flow applied at the fixing element 221 takes place through the spring element 222, which preferably has a larger inner diameter 227 than the spring element 223. Here, the force flow is preferably not compensated by the spring element 223. Rather, the force flow is preferably guided by the spring element 222 into the outer ring 265 of the upper bearing element 231. At the inner ring 266 of the bearing element 231, the force flow is preferably guided via the end face 343 of the spacer element 240 facing the bearing element 231 into the spacer element 240. Via the end face 342 facing the lower bearing element 232, the force flow is preferably guided into the inner ring 268 of the bearing element 232. Alternatively thereto, the force flow may be guided via the upper interference fit between the inner circumference 262 of the inner ring 266 and the outer circumference 211 of the spindle 125 and via the lower interference fit between the outer circumference 211 of the spindle and the inner circumference 264 of the inner ring 268. Finally, the force flow is preferably dissipated via the outer ring 267 of the bearing element 232 into the stator 310.

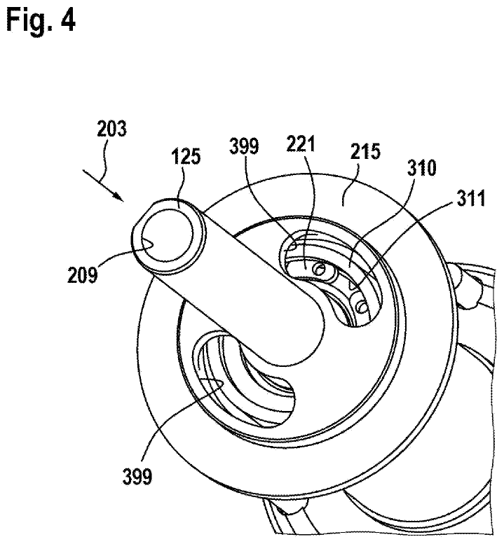

FIG. 4 shows the spindle 125 having the magnet carrier 215, as well as the stator 310 of FIG. 3, as viewed from the first end 203. FIG. 4 illustrates the at least one, illustratively two recesses 399, of the magnet carrier 215 for engagement into the inner receptacle 311 of the stator 310 for positioning the fixing element 221 in the fixing receptacle 312 of the inner receptacle 311 of FIG. 3. The recesses 399 are at least approximately arcuate. By way of example, the two recesses 399 are arranged diametrically opposite one another.

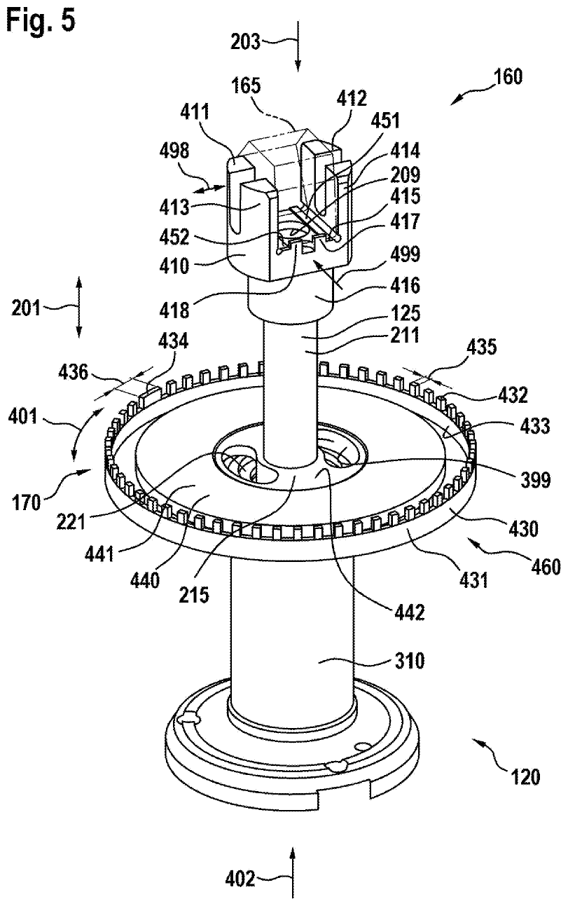

FIG. 5 shows the spindle 125 having the stator 310 of FIG. 1 to FIG. 4 and the beam deflector 165 of FIG. 1. The drive unit 120 of FIG. 1 preferably comprises the stator 310 and a rotor 460 for rotatably driving the spindle 125. Preferably, the drive unit 120 is formed as a spindle motor. In this case, the drive unit 120 is preferably formed as a brushless DC motor.

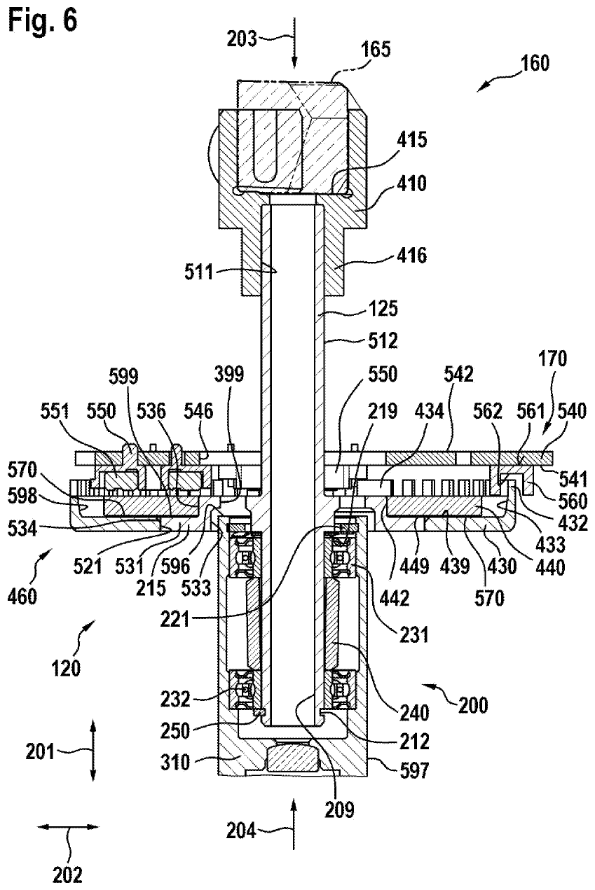

A magnetic disk 440 is, by way of example, assigned to the rotor 460 and two coils (551 in FIG. 6) are, by way of example, assigned to the stator 310. By energization of the coils (551 in FIG. 6), the spindle 125 may be set into rotation or subjected to a holding torque for static positioning.

The laser diode 135 of FIG. 1 is preferably arranged at an end 402 of the stator 310 facing away from the beam deflector 165. A laser beam generated by the laser diode 135 is guided along the interior recess 209 of the spindle 125 toward the beam deflector 165. The laser beam is deflected by the beam deflector 165. Preferably, the beam deflector 165 is formed as a pentaprism. A pentaprism, also pentagonal prism, is understood to mean a five-sided optical prism. Here, two of the five surfaces are used as internal reflection surfaces. Preferably, the laser beam is deflected in a perpendicular direction. By rotation of the spindle 125, a plane assigned to the laser beam may thus be projected when the laser beam is deflected. Furthermore, the beam deflector 165 may be formed as a beam splitter that divides the laser beam generated by the laser diode 135 into a parallel laser beam (emitted upward along the longitudinal extent 201) and a perpendicular laser beam.

Preferably, the determination unit 170 of FIG. 1 is assigned to the spindle 125. The determination unit 170 comprises, by way of example, a toothed disk 430 and a photointerrupter (560 in FIG. 6). The toothed disk 430 comprises a base body 431. Preferably, the base body 431 is formed in a shell shape having a receptacle 433. The receptacle 433 is preferably configured for at least partial reception of the magnetic disk 440. Preferably, the toothed disk 430 comprises teeth 432 arranged distributed in the circumferential direction 401. The teeth 432 are formed on an outer circumference of the toothed disk 430 along the longitudinal extent 201 of the spindle 125.

Preferably, the determination unit 170 comprises a reference mark 434 as an absolute reference. The reference mark 434 is preferably assigned to the toothed disk 430. The reference mark 434 may, for example, be formed as a reference tooth or a reference recess. Here, the teeth 432 of the toothed disk 430 have a first width 435, and the reference tooth 434 or the reference recess has a second width 436. The second width 436 is preferably greater than the first width 435.

The magnetic disk 440 preferably comprises a base body 441 that is at least in sections annular. The annular base body 441 preferably comprises an inner receptacle 442. The inner receptacle 442 is preferably arranged on the inner shoulder (536 in FIG. 6) of the magnet carrier 215 of the spindle 125. Alternatively, the magnetic disk 440 may comprise at least two magnet parts. Preferably, the magnetic disk 440 is formed as a permanent magnet having N pole pairs. The magnet carrier 215 of the spindle 125 and the toothed disk 430 may be formed in one piece.

At its end 203 facing away from the stator 310, the spindle 125 comprises the rotating head 160 having the beam deflector 165. The beam deflector 165 comprises, by way of example, a holder 410, by way of which it is arranged at the end 203 of the spindle 125. For this purpose, the holder 410 preferably comprises a fastening section 416 for arrangement at the first end 203 of the spindle 125. Preferably, the fastening section 416 is formed in one piece with the holder 410. Alternatively, the fastening section 416 may be connected to the holder 410. The fastening section 416 is arranged on the outer circumference 211 of the spindle 125. Preferably, the fastening section 416 is connected to the spindle 125. Furthermore, the holder 410 comprises at least two, four receiving elements 411, 412, 413, 414, which form a preferably central receptacle 415. The beam deflector 165 is preferably receivable in the receptacle 415. The beam deflector 165 is received in the receptacle 415. Here, the at least two receiving elements 411, 412, 413, 414 are preferably configured to mechanically fix the beam deflector 165 in the receptacle 415.

The at least two receiving elements 411, 412, 413, 414 are preferably formed as webs extending along the longitudinal extent 201 of the spindle 125. The receiving elements 411, 412, 413, 414 are preferably arranged facing away from the spindle 125. The at least two receiving elements 411, 412, 413, 414 are formed in one piece with the holder 410. Alternatively, the at least two receiving elements 411, 412, 413, 414 may be connected to the holder 410.

The receptacle 415 preferably comprises at least one, two positioning surfaces 451, 452 for positioning the beam deflector 165. The positioning surfaces 451, 452 are preferably arranged on a bottom surface facing the spindle 125. At at least one end face 499 of the two positioning surfaces 451, 452, at least one, illustratively two stops 417, 418 may be formed. The stops 417, 418 are, by way of example, formed along the longitudinal extent 201 of the spindle 125 and form a retaining edge for the beam deflector 165. Preferably, the receiving elements 411, 412, 413, 414 and/or the stops 417, 418 are formed in one piece with the holder 410. Preferably, the receiving elements 411, 412, 413, 414 and/or the stops 417, 418 are connected to the holder 410 via a connection.

Two receiving elements 411, 413 are arranged to the left of the beam deflector 165 and two receiving elements 412, 414 are arranged to the right of the beam deflector 165. Preferably, the left receiving elements 411, 413 and the right receiving elements 412, 414 are spaced apart from one another in a transverse direction 498 relative to the end face 499. Alternatively or optionally, the beam deflector 165 is fixed in the receptacle 415 by way of at least one adhesive bond.

FIG. 6 shows the drive unit 120 having the spindle 125, the stator 310, the rotor 460, the beam deflector 165, and the determination unit 170 of FIG. 5. FIG. 6 illustrates a photointerrupter 560 assigned to the determination unit 170. The photointerrupter 560 is preferably provided for determining a relative change of an angular position of the spindle 125 in the circumferential direction 401 of FIG. 5.

Preferably, the photointerrupter 560 is formed as a quadrature encoder. Preferably, such a quadrature encoder comprises two photointerrupters, which are preferably arranged relative to one another with an offset in the circumferential direction 401 of FIG. 4 of half a tooth width, or half the first width 435. Alternatively, the offset may amount to half a tooth width plus an integer multiple of the tooth width. By measuring a tooth pattern assigned to the toothed disk 430 at two positions having a phase offset of, by way of example, 90°, the rotational direction may be determined stepwise. A common light source is preferably assigned to the preferably two photointerrupters. Furthermore, two preferably separate photodiodes or phototransistors are assigned to the preferably two photointerrupters.

The photoelectric barrier 560 comprises a bottom surface 561 and a preferably U-shaped receptacle 562. In the U-shaped receptacle 562, the teeth 432 of the toothed disk 430 are preferably received at least in sections. The bottom surface 561 of the photointerrupter 560 is arranged on an underside 541 of a printed circuit board 540 facing the toothed disk 430.

The printed circuit board 540 is preferably arranged in the housing 110 of the rotating laser 100 of FIG. 1. Here, the printed circuit board 540 is preferably arranged parallel to the toothed disk 430. By way of example, the printed circuit board 540 comprises an interior recess 546 for coaxial arrangement on the spindle 125. The printed circuit board 540 comprises an upper side 542, illustratively arranged facing the beam deflector 165, and the underside 541, by way of example, arranged facing the toothed disk 430. Preferably, the printed circuit board 540 comprises two coils 551. The coils 551 are arranged on the underside 541 of the printed circuit board 540. Preferably, the coils 551 are arranged on the printed circuit board 540 by way of coil holders 550. Preferably, the coil holders 550 are fixed on the printed circuit board 540.

The interior recess 442 of the magnetic disk 440 is arranged on an inner shoulder 536 of the magnet carrier 215. As a result, a centering of the magnetic disk 440 may be achieved in a simple manner. The magnet carrier 215 preferably comprises a circumferential collar 531, which extends the magnet carrier 215 in the radial direction. Furthermore, the magnetic disk 440 rests against the circumferential collar 531 along the longitudinal extent 201 of the spindle 125, or the magnetic disk 440 rests at least in sections on an upper side 599 of the circumferential collar 531 facing the beam deflector 165.

Preferably, the toothed disk 430 comprises an interior recess 521, which is arranged on an outer circumference 534 of the circumferential collar 531. Preferably, the receptacle 433 and the circumferential collar 531, or the upper side 599 of the circumferential collar 531, form a receptacle 598 for receiving the magnetic disk 440. Furthermore, the magnet carrier 215 comprises an inner receptacle 533 facing the stator 310. Preferably, the inner receptacle 533 is configured in sections to receive the stator 310. Preferably, the stator 310 is arranged coaxially with the inner receptacle 533. Here, an outer circumference 597 of the stator 310 is preferably spaced apart in the radial direction 202 from the inner receptacle 533. Furthermore, an end face 596 of the stator 310 facing the magnet carrier 215 is preferably spaced apart from the magnet carrier 215. Thus, the stator 310 may be arranged in the housing 110 of the rotating laser 100 of FIG. 1 and the spindle 125 may rotate without collision with the magnet carrier 215, while at the same time a compact arrangement of the stator 310 and the magnet carrier 215 having the circumferential collar 531 may be enabled.

Preferably, the magnetic disk 440 is fixed in the receptacle 598 or 433 by way of a material-bonded connection. Preferably, an adhesive 570 for the formation of the material-bonded connection, by way of example, is arranged between an underside 449 of the magnetic disk 440, by way of example, assigned to the magnetic disk 440 and facing the toothed disk 430, and a bottom surface 439 of the toothed disk 430, facing the magnetic disk 440. As a result, the toothed disk 430 may also be fixed on the circumferential collar 531 of the magnet carrier 215. The adhesive 570 may, for example, be formed as a double-sided adhesive tape for forming the exemplary material-bonded connection.

Furthermore, FIG. 6 illustrates, by way of example, an inner receptacle 511 assigned to the fastening section 416 of the holder 410. The inner receptacle 511 is preferably configured for arrangement on the outer circumference 211 of the spindle 125. Preferably, the spindle 125 comprises, at its upper end 203, a receptacle 512 which is arrangeable in the inner receptacle 511 of the holder 410. The inner receptacle 511 comprises a diameter assigned to the outer circumference 211 of the receptacle 512 of the spindle 125.

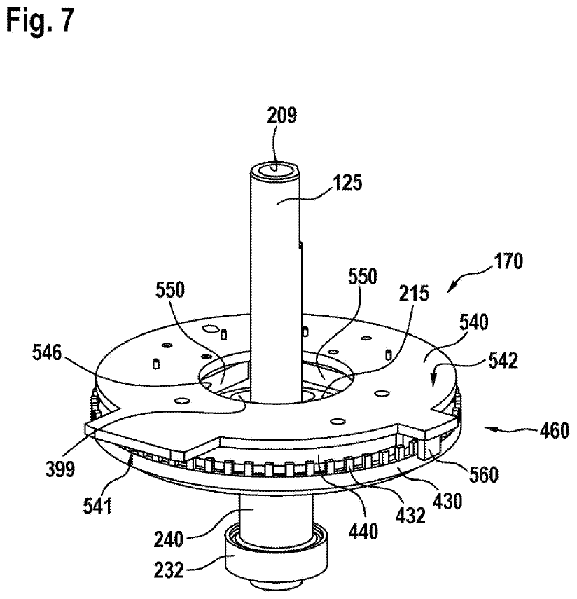

FIG. 7 shows the spindle 125 with the rotor 460, that is to say the toothed disk 430, the magnetic disk 440, and the printed circuit board 540 with the two coil holders 550 of FIG. 6. FIG. 7 illustrates the coaxial arrangement of the printed circuit board 540 relative to the spindle 125. Through the interior recess 546 of the printed circuit board 540 and the at least one recess 399 of the magnet carrier 215 of the spindle 125, the fixing element 221 of FIG. 2 to FIG. 6 may be arranged for fixing in the stator 310 of FIG. 3 to FIG. 6 in the fixing receptacle 312 of FIG. 3.

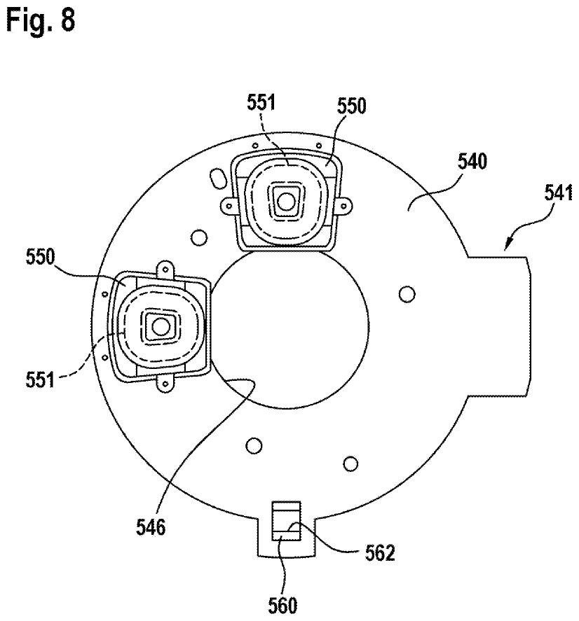

FIG. 8 shows the printed circuit board 540 of FIG. 5 and FIG. 6 as viewed from its underside 541. As described above, preferably two coils 551 are arranged on the underside 541 of the printed circuit board 540 by way of a coil holder 550. Furthermore, the photointerrupter 560 is preferably arranged on the underside 541 of the printed circuit board 540. The two coils 551 are arranged offset relative to one another by 90°. Preferably, the photointerrupter 560 is arranged opposite one of the two coils 551, or offset therefrom by 180°.

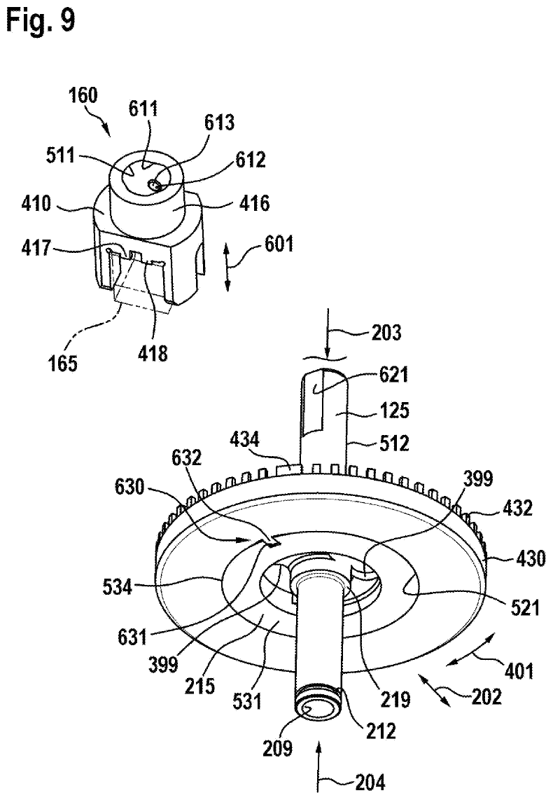

FIG. 9 shows the spindle 125 of FIG. 1 to FIG. 8 having the toothed disk 430 and the beam deflector 165 of FIG. 5 and FIG. 6. According to FIG. 9, the toothed disk 430 preferably comprises at least one first positive-locking element 632 at its interior recess 534, and the circumferential collar 531 of the magnet carrier 215 of the spindle 125 comprises at least one second positive-locking element 631 at its outer circumference 534. The at least one first positive-locking element 632 and the at least one second positive-locking element 631 form, by way of example, a positive-locking connection 630.

The first positive-locking element 632 of the toothed disk 430 is configured as an extension in the radial direction 202 of the spindle 125 and the second positive-locking element 631 of the magnet carrier 215 is configured as a recess in the radial direction 202 of the spindle 125. Alternatively, the second positive-locking element 631 of the magnet carrier 215 is formed as an extension in the radial direction 202 of the spindle 125 and the first positive-locking element 632 of the toothed disk 430 is configured as a recess in the radial direction 202 of the spindle 125. Furthermore, the toothed disk 430 and the magnet carrier 215 may also comprise a plurality of first and second positive-locking elements 632, 631 arranged distributed in the circumferential direction 401 of the spindle 125.

Preferably, the spindle 125 comprises a flat portion 621 at the first end 203 for positioning the beam deflector 165. The flat portion 621 is preferably arranged on the receptacle 512 of the spindle 125. As described above, the holder 410 of the beam deflector 165 preferably comprises the fastening section 416 having the corresponding inner receptacle 511. Preferably, the inner receptacle 511 of the fastening section 416 comprises a flat portion 611 assigned to the flat portion 621 of the spindle 125. Preferably, the flat portion 611 of the inner receptacle 511 of the holder 410 comprises a recess 613, in which a clamping element 612 is arranged. The recess 613 is formed in the radial direction 601 of the inner receptacle 511. Preferably, the recess 613 is formed as a threaded recess, and the clamping element 612 is a screw, in particular, a grub screw.

If the holder 410 of the beam deflector 165, or the inner receptacle 511, is arranged on the receptacle 512 of the spindle 125, the two flat portions 621, 611 are preferably arranged abutting one another. Thus, defined positioning of the holder 410, in particular, of the beam deflector 165, on the spindle 125 may be achieved. By screwing in the threaded pin 612, the threaded pin 612 may be biased against the flat portion 621 of the spindle 125, and the holder 410 may thus fix the beam deflector 165 to the spindle 125.

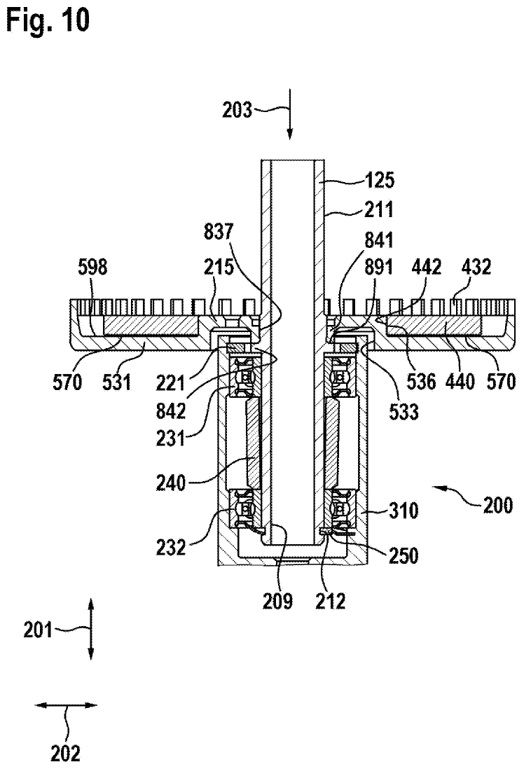

FIG. 10 shows the spindle 125 of FIG. 1 to FIG. 9, which is supported in the stator 310 by way of the bearing arrangement 200 of FIG. 2, FIG. 3, and FIG. 6, as well as having the toothed disk 430 of FIG. 5 to FIG. 7 and FIG. 9. The toothed disk 430 of FIG. 10 is formed in one piece with the magnet carrier 215 of FIG. 2 to FIG. 6 and FIG. 9. For this purpose, the magnet carrier 215 preferably comprises a bearing section 841 having an inner receptacle 837. The inner receptacle 837 is arranged, by way of example, on the outer circumference 211 of the spindle 125. For positional fixing of the toothed disk 430, or of the magnet carrier 215, the spindle 125 preferably comprises a circumferential collar 842 along its longitudinal extent 201. For positional fixing of the toothed disk 430, the bearing section 841 preferably abuts, along the longitudinal extent 201 of the spindle 125, a side 891 facing the first end 203 of the spindle 125.

Preferably, the toothed disk 430 of FIG. 10 forms the receptacle 598 for receiving the magnetic disk 440. Preferably, the inner receptacle 442 of the magnetic disk 440 is arranged on the inner shoulder 536 of the magnet carrier 215, wherein the inner shoulder 536, according to the one-piece configuration of the toothed disk 430 and the magnet carrier 215, is assigned to the toothed disk 430. Analogously to FIG. 6, the magnetic disk 440 is preferably fixed in the receptacle 598 by way of an adhesive bond having the adhesive 570.

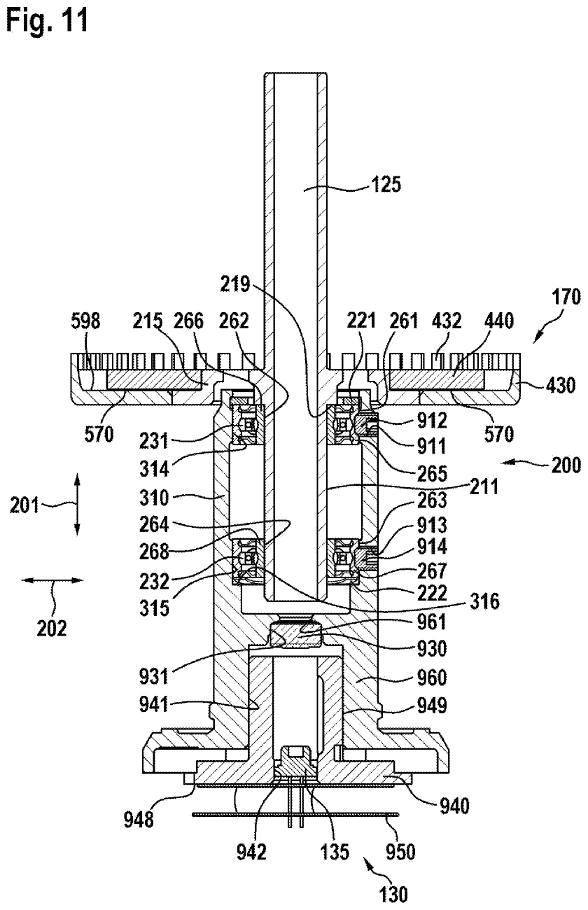

FIG. 11 shows the spindle 125 of FIG. 1 to FIG. 10 having the stator 310 of FIG. 3 to FIG. 6 and FIG. 10. Preferably, the stator 310 comprises at least one recess 911, 913, which is arranged perpendicular to the inner receptacle 311. The at least one recess 911, 913 is arranged along the longitudinal extent 201 of the spindle 125 in the region of at least one bearing seat 314, 315. Preferably, a clamping connection is formed between a clamping element 912, 914 assigned to one of the at least one recesses 911, 913 and an outer circumference 261, 263 of one of the two bearing elements 231, 232. By way of example, a first clamping connection is formed between the outer circumference 261 of the upper bearing element 231 and the clamping element 912, and a second clamping connection is formed between the outer circumference 263 of the lower bearing element 232 and the clamping element 914. By way of example, the clamping elements 912, 914 are formed as screws, in particular, grub screws. By way of the clamping elements 912, 914, play between the stator 310 and the assigned bearing element 231, 232 may be eliminated at least substantially, that is to say within customary manufacturing tolerances.

Furthermore, FIG. 11 illustrates the laser unit 130 of FIG. 1. The laser unit 130 comprises a laser module housing 960 having an inner receptacle 961 for outputting or emitting a laser beam generated and collimated by the laser diode 135. The laser module housing 960 may be formed in one piece with the stator 310.

For collimation of the laser beam, the laser unit 130 preferably comprises a collimation lens 930. Here, the collimation lens 930 is preferably arranged, and preferably fixed, in an upper receiving section 931 of the inner receptacle 961 of the laser module housing 960. The collimation lens 930 is preferably fixed in the inner receptacle 961, or the receiving section 931, by way of a material-bonded connection and/or a press connection.

Furthermore, a laser diode holder 940 is arranged in the inner receptacle 961, in particular, in a lower receiving section 941. Preferably, a press connection is formed, at least in sections, between an outer circumference 949 of the laser diode holder 940 and the receiving section 941. Alternatively, the laser diode holder 940 may be fixed in the inner receptacle 961, or the receiving section 941, via a material-bonded connection.

The laser diode holder 940 comprises an inner receptacle 942. In the inner receptacle 942, the laser diode 135 for generating a laser beam is preferably arranged. The laser diode 135 is preferably arranged on a printed circuit board 950. Preferably, the printed circuit board 950 is formed as a flexible printed circuit board. The printed circuit board 950 is arranged on an underside 948 of the laser diode holder 940 facing away from the stator 310. Preferably, the printed circuit board 950 is fixed on the laser diode holder 940 by way of a material-bonded connection. According to one embodiment, the material-bonded connection is an adhesive bond. Here, the adhesive is preferably a double-sided adhesive tape.

Preferably, a monitor diode is assigned to the laser diode 135. The monitor diode is preferably configured to measure a laser power assigned to the laser diode 135. Here, the monitor diode may be a monitor diode integrated into the laser diode 135. Preferably, the laser unit 130 comprises a photodiode, not shown, which is provided for measuring the laser power independently of the monitor diode.

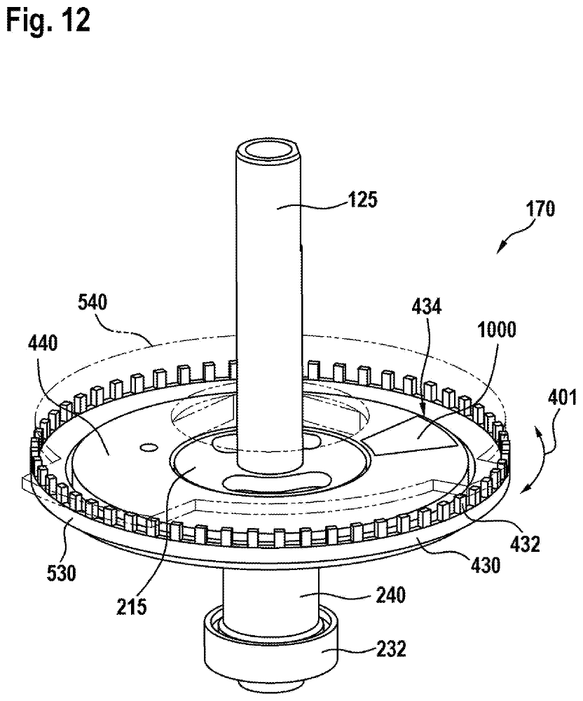

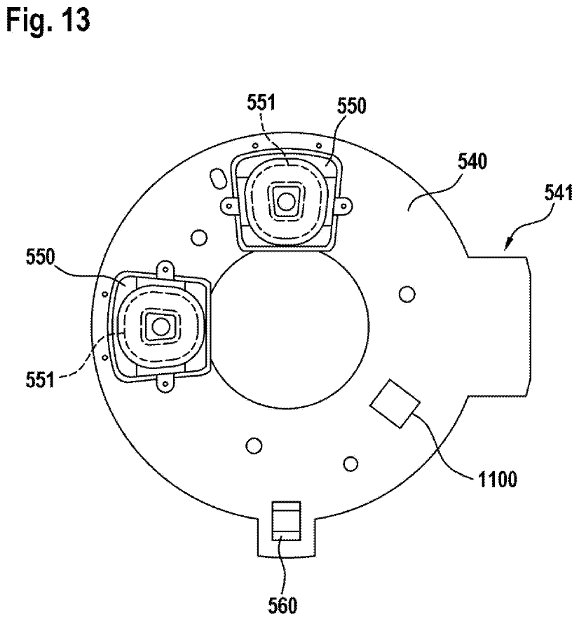

FIG. 12 shows the spindle 125 of FIG. 1 to FIG. 11 having the toothed disk 430, the magnetic disk 440, as well as the printed circuit board 540, which is shown transparently for improved illustration. The toothed disk 430 according to FIG. 12 comprises only the teeth 432 having the first width 435 arranged distributed on the outer circumference. The reference mark 434 is formed as a positioning feature 1000 on the magnetic disk 440 and operatively connected to an absolute encoder (1100 in FIG. 13).

Here, a mechanically defined alignment of the beam deflector 165, the magnetic disk 440, and the toothed disk 430 relative to one another is not required. Absolute positioning is preferably carried out by way of an additional component, for example a reflective light sensor, here, by way of example, in the form of an absolute encoder (1100 in FIG. 11) on the printed circuit board 540 and a positioning feature 1000 on the magnetic disk 440. The positioning feature 1000 is preferably a reflective or light-absorbing sticker.

The positioning feature 1000 is preferably configured to identify one of the pole pairs of the magnetic disk 440. If the magnetic disk 440 comprises N pole pairs, the positioning feature 1000 must permit identification of an angular range having a width smaller than 360°/N. Preferably, the positioning feature 1000 comprises a width of 180°/N in the circumferential direction 401 of the spindle 125. Within each identified pole pair, precise position determination is carried out via the (electrical) angle of a magnetic field generated by the coils 551 in FIG. 6 and FIG. 8. The ascertainment of this angle is preferably achieved in the manufacturing process by arbitrary angular positioning of the spindle 125 by way of the coil field within the positioning feature 1000.

FIG. 13 shows the printed circuit board 540 of FIG. 5, FIG. 6, and FIG. 12 as viewed from its underside 541 facing the magnetic disk 440. As described above, preferably two coils 551 are arranged on the underside 541 of the printed circuit board 540 by way of a coil holder 550. Furthermore, the photointerrupter 560 is arranged on the underside 541 of the printed circuit board 540. Furthermore, an absolute encoder 1100 assigned to the positioning feature 1000 of FIG. 12 is arranged, by way of example, on the underside 541 of the printed circuit board 540.

FIG. 14a to FIG. 14c show an exemplary calibration process 1200 of the positioning feature 1000 of FIG. 12 of the magnetic disk 440 and of the absolute encoder 1100 of FIG. 11 assigned to the printed circuit board 540. FIG. 14a to FIG. 14c visualize, by way of example, a magnetic pole 1240 of the magnetic disk 440, a laser beam 1210 deflected at the beam deflector 165, and a main axis 1230 along which the laser beam 1210 is to be oriented. By way of example, five magnetic poles 1240 are shown.

In FIG. 14a, by way of example, the coil field of the coils 551 of FIG. 13 orients a magnetic field of the magnetic disk 440 along the main axis 1230, wherein the positioning feature 1000 and the beam deflector 165 are arranged in an arbitrary position. Here, the laser beam 1210 is spaced apart from the main axis 1230 by an angle 1220. By way of example, the laser beam 1210 is arranged to the left of the main axis 1230 by the angle 1220.

In FIG. 14b, the coil field was rotated until, by way of example, the laser beam 1210 lies on the main axis 1230. This is preferably detected by a suitable detection device sufficiently known to the person skilled in the art. A first angle assigned to the coil field is then preferably stored.

In FIG. 14c, the coil field is preferably further rotated until the absolute encoder 1100 lies within the positioning feature 1000. The absolute encoder 1100 is arranged centrally within the positioning feature 1000. Here, the laser beam 1210 is preferably spaced apart from the main axis 1230 by an angle 1209. The laser beam 1210 is arranged to the right of the main axis 1230 by the angle 1209.

A second angle assigned to the coil field is then preferably stored. The second angle preferably defines the position of the positioning feature 1000 within a pole pair, or magnetic pole 1240. The angular difference between the first and second angle preferably defines the coil field path from the positioning feature 1000 to the sought laser position.

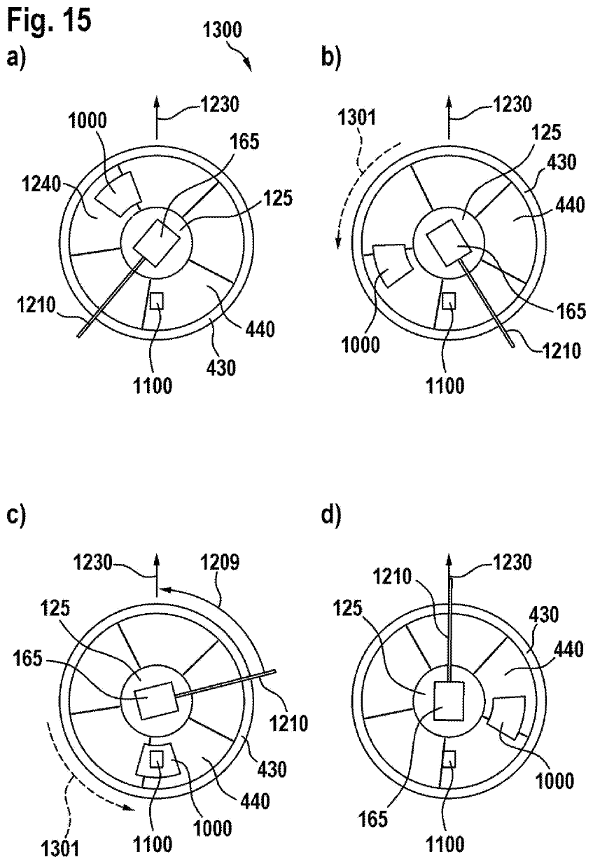

FIG. 15a to FIG. 15d show an exemplary absolute positioning process 1300 at a start of the rotating laser 100 of FIG. 1 starting from the calibration process according to FIG. 14a to FIG. 14c.

In FIG. 15a, by way of example, the coil field of the coils 551 of FIG. 13 orients the magnetic field of the magnetic disk 440 along the second angle according to FIG. 14c. Preferably, the absolute position is ascertained exactly up to an angular section of a pole pair.

In FIG. 15b, the coil field is, by way of example, rotated in the direction of an arrow 1301. The coil field is preferably rotated by 360°/N, that is to say by one pole pair, or magnetic pole 1240, until the absolute encoder 1100 detects the positioning feature 1000. In particular, the coil field is preferably rotated by one pole pair up to N-1 times, that is to say one time fewer than the number of pole pairs.

In FIG. 15c, the spindle 125 is now, by way of example, in an absolute position W2, or the position according to FIG. 14c. Subsequently, the coil field is preferably rotated by the angular difference of the first and second stored angles determined according to FIG. 14a and FIG. 14b.

In FIG. 15d, the laser beam 1210 is oriented along the main axis 1230. In this position, the photointerrupter 560 of FIG. 13 is preferably reset.

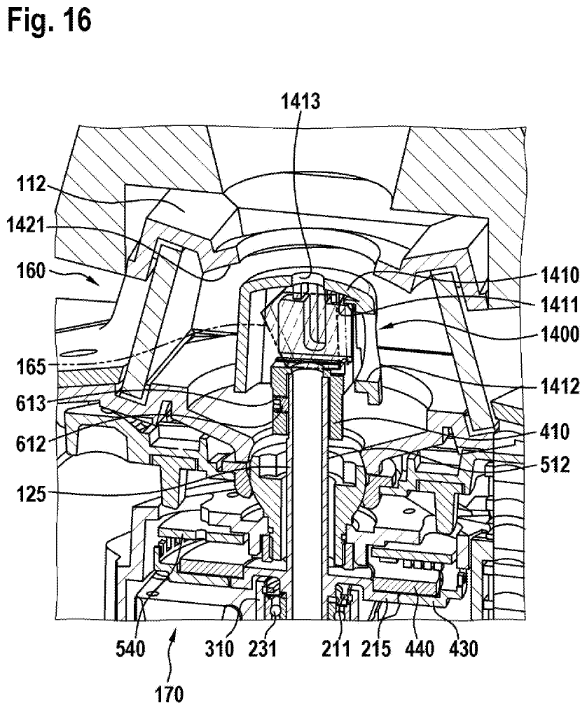

FIG. 16 shows the housing 110 having the rotating head 160, or the beam deflector 165, and the spindle 125 of FIG. 1 to FIG. 15. FIG. 16 illustrates the cage 112 assigned to the rotating head 160, which is preferably configured to protect against striking of the rotating head 160. The cage 112 preferably forms an upper part of the housing 110 of FIG. 1. Preferably, the cage 112 is assigned to the holder 410 of the beam deflector 165. Here, the cage 112 forms an inner receptacle 1421 for receiving the beam deflector 165. Preferably, the cage 112 comprises metal and/or plastic.

By way of example, a cap 1400 is assigned to the holder 410. The cap 1400 is preferably formed as an additional protective measure to protect against the beam deflector 165 striking the housing 110 or the cage 112. Here, the cap 1400 fixes the beam deflector 165 on the holder 410. The cap 1400 comprises, by way of example, a base body 1410 having an inner receptacle 1411 for receiving the holder 410. Preferably, the base body 1410 is formed at least approximately cylindrical. Preferably, the cap 1400, or the base body 1410, comprises an upper recess 1413. Furthermore, the cap 1400, or the base body 1410, preferably comprises a right receptacle 1412. The receptacle 1412 is preferably assigned for receiving a wedge prism (1520 in FIG. 15) assigned to the beam deflector 165.

Preferably, the cap 1400 is fastened to the holder 410 by way of a clamping connection or a latching connection. Preferably, the cap 1400 comprises plastic.

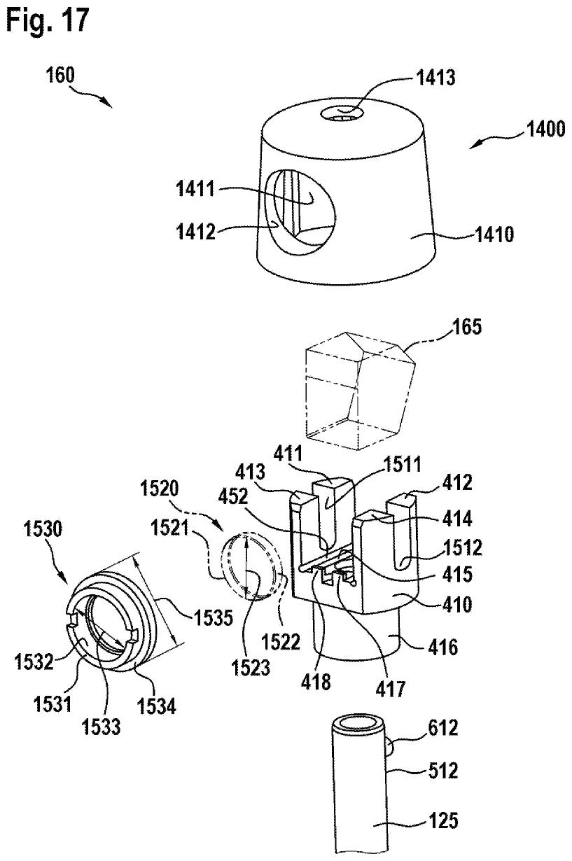

FIG. 17 shows the rotating head 160 having the spindle 125, the holder 410, the beam deflector 165, and the cap 1400 of FIG. 16. Preferably, a wedge prism 1520 is assigned to the beam deflector 165. Preferably, the wedge prism 1520 comprises a disk-shaped base body 1521 having an outer circumference 1522 and a diameter 1523.

Preferably, a wedge prism holder 1530 is assigned to the wedge prism 1520. The wedge prism holder 1530 comprises, by way of example, an annular base body 1531 having an inner receptacle 1532 having an inner diameter 1533. Furthermore, the base body 1531 comprises a circumferential collar 1534, which extends the base body 1531 in the radial direction and comprises an outer diameter 1535. Preferably, the lateral receptacle 1412 of the cap 1400 is configured to receive the wedge prism 1520.

Furthermore, FIG. 17 illustrates the receiving elements 411, 412, 413, 414 assigned to the holder 410 of the beam deflector 165. A recess 1511 is formed between the receiving elements 411, 413 and/or a recess 1512 is formed between the receiving elements 412, 414. The two recesses 1511, 1512 are preferably arranged transversely, in particular, perpendicularly, to the two positioning surfaces 451, 452.

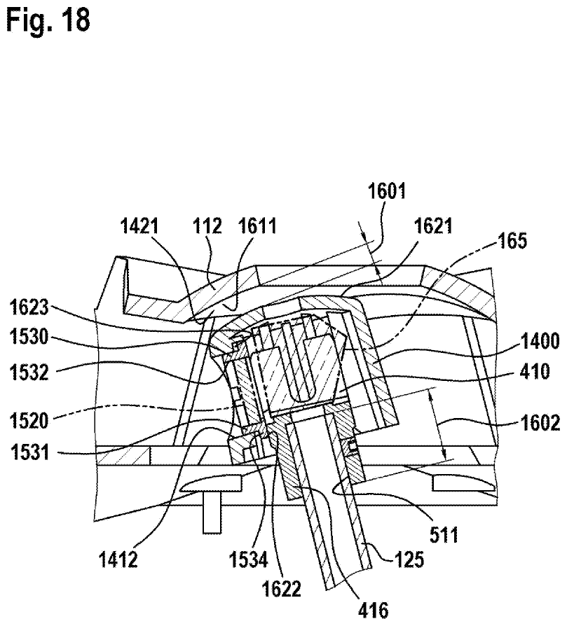

FIG. 18 shows the cage 112 having the inner receptacle 1421 of FIG. 16, which comprises an interior surface 1611 facing the beam deflector 165, as well as the beam deflector 165 having the cap 1400 of FIG. 16 and FIG. 17, and the spindle 125 of FIG. 1 to FIG. 7, FIG. 9 to FIG. 12, and FIG. 14a to FIG. 17. Preferably, the inner receptacle 1611 is formed in an arcuate shape, such that striking against the inner receptacle 1611 may be prevented when the beam deflector 165 is pivoted.

Preferably, a distance 1601 is formed between the interior surface 1611 of the cage 112 and a surface 1621 of the cap 1400 assigned to the holder 410. Furthermore, the inner receptacle 511 of the holder 410 has a depth 1602. The distance 1601 is preferably smaller than the depth 1602 of the inner receptacle 511.

Furthermore, FIG. 18 illustrates the exemplary arrangement of the wedge prism 1520 by way of the wedge prism holder 1530 on the cap 1400. Preferably, the wedge prism holder 1530 is arranged in the receptacle 1412 of the cap 1400. Preferably, the receptacle 1412 widens into the receptacle 1622 via a retaining edge 1623. Preferably, the circumferential collar 1534 of the wedge prism holder 1530 is arranged in the receptacle 1622 and abuts the retaining edge 1623. The base body 1531 of the wedge prism holder 1530 is arranged in the receptacle 1412. The wedge prism 1520 is preferably arranged in the inner receptacle 1532 of the base body 1531.

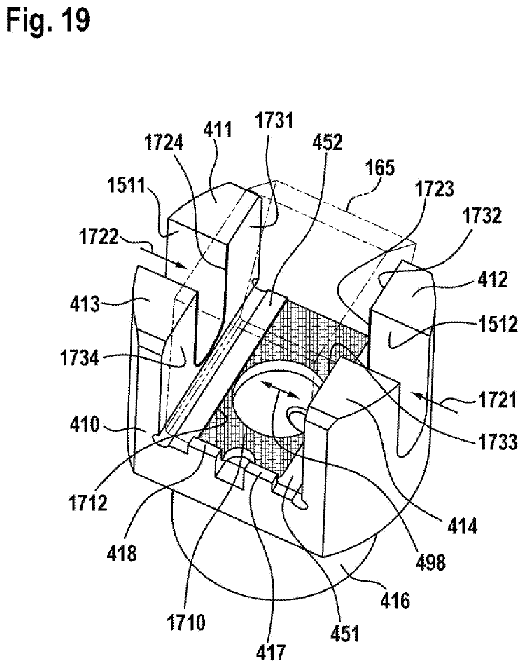

FIG. 19 shows the holder 410 having the beam deflector 165 of FIG. 17. Preferably, along the transverse direction 498 of the two positioning surfaces 451, 452, an adhesive receptacle 1712 for receiving a first adhesive 1710 is arranged between the two positioning surfaces 451, 452. Preferably, the adhesive receptacle 1712 has a receptacle height of 0.2 mm along the longitudinal extent 201 of the spindle 125. As a result, a capillary effect may be generated. Preferably, the first adhesive 1710 forms a planar adhesive bond.

Furthermore, in at least one, preferably in both recesses 1511, 1512, which are transverse, in particular, perpendicular, to the two positioning surfaces 451, 452 and are arranged between a first receiving element 411, 412 and a second receiving element 413, 415, a second adhesive 1723, 1724 is preferably arranged for forming a second adhesive bond 1721, 1722. Here, the adhesive bond 1721 is formed in the recess 1512 and/or the adhesive bond 1722 in the recess 1511. Preferably, the second adhesive bond 1723, 1724 is a fillet adhesive bond.

Furthermore, a side 1731 of the receiving element 411 facing the beam deflector 165 and/or a side 1734 of the receiving element 413 facing the beam deflector 165 form a left stop surface of the beam deflector 165. Preferably, a side 1732 of the receiving element 412 facing the beam deflector 165 and/or a side 1733 of the receiving element 414 facing the beam deflector 165 form a right stop surface of the beam deflector 165.

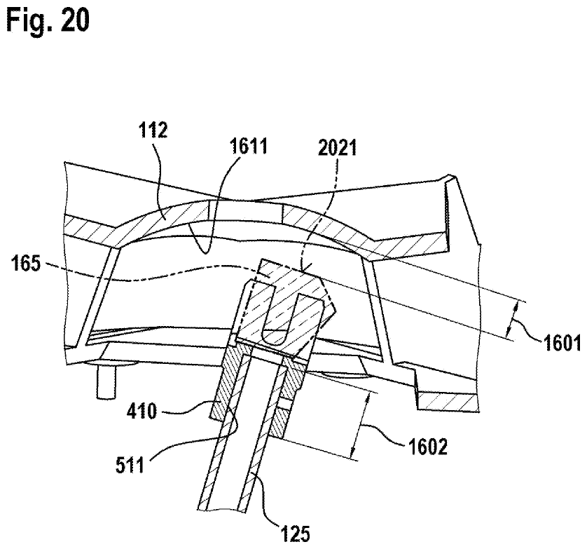

FIG. 20 shows the cage 112 of the housing 110 of FIG. 1 having the spindle 125, which has the holder 410 and the beam deflector 165. Preferably, the distance 1601 is formed between the interior surface 1611 of the cage 112 and a surface 2021 of the beam deflector 165. The distance 1601 is preferably smaller than the depth 1602 of the inner receptacle 511.

By way of the first and second adhesive bonds 1722, 1723, 1724 of FIG. 19, the beam deflector 165 is securely and reliably fastened to the holder 410. As a result, as shown in FIG. 20, the cap 1400 may be dispensed with.

In this alternative embodiment, the wedge prism is preferably fixed and arranged directly on the pentaprism by way of an optically transparent adhesive (not shown in FIG. 19 and FIG. 20 for the sake of simplicity).

What is claimed is:

1. A rotating laser, comprising:
a housing;
a drive unit arranged in the housing and configured to rotatably drive a spindle for rotation of a laser beam; and
a beam deflector arranged on the spindle and configured to deflect the laser beam,
wherein the spindle includes a holder that has at least two receiving elements which form a receptacle that is configured to receive the beam deflector, and
wherein the at least two receiving elements are configured to mechanically fix the beam deflector in the receptacle.

2. The rotating laser according to claim 1, wherein the receptacle comprises two positioning surfaces configured to position the beam deflector.

3. The rotating laser according to claim 1, wherein the beam deflector is fixed in the receptacle by way of at least one adhesive bond.

4. The rotating laser according to claim 2, wherein:
an adhesive receptacle configured to receive a first adhesive is arranged between the two positioning surfaces along a transverse direction of the two positioning surfaces, and
the first adhesive forms a planar adhesive bond.

5. The rotating laser according to claim 4, wherein a second adhesive is arranged in two recesses, which are arranged transverse to the two positioning surfaces and between a first receiving element and a second receiving element, for forming a second adhesive bond.

6. The rotating laser according to claim 5, wherein the second adhesive bond is a fillet adhesive bond.

7. The rotating laser according to claim 2, wherein a stop is formed on at least one end face of the two positioning surfaces.

8. The rotating laser according to claim 1, wherein the holder includes a fastening section for arrangement at a free end of the spindle.

9. The rotating laser according to claim 8, wherein:
the fastening section includes an inner receptacle having a flat portion, and
the spindle has, at its free end, a corresponding receptacle having a flat portion.

10. The rotating laser according to claim 1, wherein a cap having an inner receptacle configured to receive the holder is assigned to the holder.

11. The rotating laser according to claim 10, wherein the cap includes an additional receptacle configured to receive a wedge prism.

12. The rotating laser according to claim 1, wherein a cage is assigned to the holder.

13. The rotating laser according to claim 12, wherein a distance between an inner surface of the cage and a surface of the beam deflector is smaller than a depth of the inner receptacle.

14. The rotating laser according to claim 12, wherein a distance between an inner surface of the cage and a surface of a cap assigned to the holder is smaller than a depth of the inner receptacle.
